(19) United States
(12) Patent Application Publication
(10) Pub. No.: US 2026/0347039 A1
(43) Pub. Date: Nov. 5, 2026

(54) SAFETY LABELLING SYSTEM AND METHOD FOR OPERATING A SAFETY LABELLING SYSTEM

(71) Applicant: EVOLABEL AB, Mölndal (SE)

(72) Inventor: Jonatan Essman Melin, Alingsås (SE)

(21) Appl. No.: 19/488,515

(22) PCT Filed: Jun. 12, 2024
(86) PCT No.: PCT/EP2024/066217

§ 371 Date: Nov. 26, 2025

(30) Foreign Application Priority Data
Jun. 28, 2023 (SE) 2350801-3

(51) Int. Cl. B65C 9/02; B65C 1/02; B65C 9/26; B65C 9/46; F16M 11/28

(52) U.S. Cl. CPC B65C 9/02; B65C 1/021; B65C 9/26; B65C 9/46; F16M 11/28

(57) ABSTRACT

A safety labelling system comprising a lifting device and a labelling unit and method for operating a safety labelling system. The lifting device is configured for positioning the labelling unit in a vertical direction in relation to a flow of objects. The labelling unit is arranged for printing labels and/or applying labels to the objects. The lifting device comprises an upper section and a lower section, where the upper section is movably arranged relative to the lower section by a balancing displacement unit arranged between the upper section and the lower section. The balancing displacement unit comprises a cylinder barrel, a piston movably arranged in the cylinder barrel, a piston rod, and a cylinder nut. The piston rod and the cylinder nut are rotatably engaged with each other. The piston rod is at an inner end connected to the piston and the cylinder nut is connected to the cylinder barrel.

### TECHNICAL FIELD

The present disclosure relates to a safety labelling system comprising a lifting device and a labelling unit. The lifting device is positioning the labelling unit in a vertical direction in relation to a flow of objects, and the labelling unit is arranged for printing labels and/or applying labels to the objects. The disclosure further relates to a method for operating a safety labelling system.

### BACKGROUND

Lifting devices are commonly used in labelling applications, where a labelling unit is positioned in a vertical direction in relation to objects that are labelled. The objects that are labelled sometimes have different dimensions and labelling positions and therefore the labelling unit needs to be repositioned to a correct labelling position for the objects to be labelled. The labelling units are often attached to a movable stand that is used for repositioning the labelling unit. Known movable stands are often complex in construction and are repositioning the labelling unit with low speeds. It is also difficult to position the labelling unit with high precision since drive units used need to move heavy loads in short time periods, and therefore are dimensioned with high power to manage high loads. When repositioning the labelling unit there is a risk that the moving labelling unit or a part of the movable stand is interfering with persons or is damaging objects if not handled in a correct way, which also could be the case if a malfunction of the movable stand occurs. To avoid accidents, the lifting device with the labelling unit is therefore often placed in fenced areas, which is a costly solution that takes up large floor areas.

There is thus a need for an improved lifting device with a compact, safe, and simple construction, where the labelling unit can be repositioned with high speed and with high precision. Since the lifting device is robust in construction, carrying high loads, and is repositioned with high speed, there is a need to construct the lifting device to prevent accidents and damage to objects when the labelling unit is repositioned, or when the labelling unit is displaced in an unwanted manner.

### SUMMARY

An object of the present disclosure is to provide a safety labelling system and method for operating a safety labelling system, where the previously mentioned problems are avoided. This object is at least partly achieved by the features of the independent claims. The dependent claims contain further developments of the safety labelling system and method for operating a safety labelling system.

The disclosure concerns a safety labelling system comprising a lifting device and a labelling unit. The lifting device is configured for positioning the labelling unit in a vertical direction in relation to a flow of objects. The labelling unit is arranged for printing labels and/or applying labels to the objects. The lifting device comprises an upper section and a lower section, where the upper section is movably arranged relative to the lower section by means of a balancing displacement unit arranged between the upper section and the lower section. The labelling unit is attached to the upper section. The balancing displacement unit comprises a cylinder barrel, a piston movably arranged in the cylinder barrel, a piston rod, and a cylinder nut. The piston rod and the cylinder nut are rotatably engaged with each other. The piston rod is at an inner end connected to the piston and the cylinder nut is connected to the cylinder barrel. An actuator is configured for rotatably displacing the piston rod or the cylinder nut resulting in linear displacement of the piston rod and the piston relative to the cylinder barrel for moving the upper section with the labelling unit in the vertical direction. The balancing displacement unit further comprises a load balancing pressure chamber arranged in the cylinder barrel in connection to the piston. The load balancing pressure chamber is configured for counterbalancing a gravitational force exerted on the piston rod from the safety labelling system by applying a counterbalancing force onto the piston by means of fluid pressure in the load balancing pressure chamber.

Advantages with these features are that through the counterbalancing of the piston rod, the safety labelling system comprising the lifting device and the labelling unit can be constructed in a safe manner with low forces acting on the actuator and the surrounding environment. Through the counterbalancing action, the load exerted on the actuator is low, and the labelling unit can be moved with high speed and positioned with high precision since the actuator is not used for moving heavy loads. The load balancing pressure chamber is counterbalancing the gravitational force exerted on the piston rod from the safety labelling system by applying the counterbalancing force onto the piston by means of fluid pressure in the load balancing pressure chamber. The load is in this way carried by the balancing displacement unit via the load balancing pressure chamber, and therefore a smaller drive unit controlled with high precision can be used. Further, the safety labelling system is providing a safe and simple labelling arrangement, where the labelling unit can be repositioned from one position to another with high speed and with high precision through the interaction between the actuator and the load balancing pressure chamber. Since a smaller drive unit can be used, the balancing displacement unit is further used for preventing unwanted displacement of the labelling unit in the downwards direction through the applied counterbalancing force onto the piston by means of fluid pressure in the load balancing pressure chamber. A smaller drive unit is providing a safer construction, since the force exerted on the piston rod from the safety labelling system is lower compared to traditional solutions that require more powerful drive units. A smaller drive unit gives in this way low impact forces in case the labelling unit or the upper section is interfering with persons or objects. The balancing displacement unit is connected to the movable section and arranged to interact with and support the actuator and counterbalancing the gravitational force exerted on the piston rod by the labelling unit, the movable section and other parts or components of the safety labelling system connected to the labelling unit and the upper section.

In one embodiment, the inner end of the piston rod is rotatably connected to the piston via a piston bearing unit. The cylinder nut is non-rotatably connected to the cylinder barrel. The actuator is connected to the piston rod and configured for rotating the piston rod around a rotational axis upon actuation, for displacement of the upper section with the labelling unit in the vertical direction. This arrangement is providing an efficient displacement of the labelling unit, where the rotational displacement of the piston rod is transferred into a linear movement of the piston rod in the vertical direction. The piston rod is in this way displacing the upper section with the labelling unit vertically.

In one embodiment, the inner end of the piston rod is non-rotatably connected to the piston. The cylinder nut is rotatably connected to the cylinder barrel via a nut bearing unit. The actuator is connected to the cylinder nut and configured for rotating the cylinder nut around a rotational axis upon actuation, for displacement of the upper section with the labelling unit in the vertical direction. This arrangement is providing an efficient displacement of the labelling unit, where the rotational displacement of the cylinder nut is transferred into a linear movement of the piston rod in the vertical direction. The piston rod is in this way displacing the upper section with the labelling unit vertically.

In one embodiment, the balancing displacement unit is arranged inside the upper section and the lower section. This arrangement is enabling a compact and safe construction of the safety labelling system, where the balancing displacement unit also is protected from dust or other contaminants.

In one embodiment, the upper section and the lower section are telescopically arranged relative to each other. This arrangement is enabling a compact design of the lifting device. The lifting device is in this way extendable and retractable in the vertical direction through a sliding movement between the upper section and the lower section. The upper section and the lower section are through the telescopic arrangement moving in an overlapping relationship in the vertical direction relative to each other.

In one embodiment, an outer end of the piston rod is connected to the upper section, and the cylinder barrel is connected to the lower section. With this configuration, the balancing displacement unit is efficiently displacing the upper section relative to the lower section for positioning the labelling unit.

In one embodiment, the upper section comprises an upper support bracket and the lower section comprises a lower support bracket. The outer end of the piston rod is connected to the upper support bracket and the cylinder barrel is connected to the lower support bracket. The support brackets are enabling secure attachment of the balancing displacement unit to the upper section and the lower section respectively.

In one embodiment, the piston rod is configured as a ball screw and the cylinder nut is configured as a ball nut, or the piston rod is configured as a threaded screw and the cylinder nut is configured as a threaded nut. The ball screw arrangement provides an efficient and cost effective solution that can control the movement of the upper section and the labelling unit with high precision. The ball screw arrangement can be efficiently controlled with the actuator and steered with high precision during linear displacement of the piston rod. The threaded screw arrangement is providing an efficient alternative solution.

In one embodiment, the actuator is arranged to control the position of the labelling unit in the vertical direction in relation to the flow of objects through displacing the upper section in an upwards direction and/or a downwards direction to a labelling position of the labelling unit. In the labelling position, the labels are printed and/or applied to the objects.

In one embodiment, the load balancing pressure chamber is configured as a pneumatic cylinder chamber. The load balancing pressure chamber is pressurized by means of compressed air from an air pressure source for establishing the counterbalancing force onto the piston for counterbalancing the gravitational force exerted on the piston rod. The pneumatic cylinder chamber provides an efficient and cost effective solution. The pneumatic cylinder chamber can be efficiently controlled with valves and regulators to balance the gravitational force. The pneumatic cylinder chamber is further enabling a solution with a constant pneumatic force independent of the position of the piston, which pneumatic force also is possible to control in a stepless manner.

In one embodiment, the actuator is arranged inside the upper section and/or the lower section. The arrangement of the actuator inside the upper section and/or the lower section gives a compact and efficient design of the lifting device.

In one embodiment, the actuator is a stepper motor adapted for rotatably positioning the piston rod or the cylinder nut with high precision.

In one embodiment, the safety labelling system is provided with a safety brake arrangement configured to prevent the upper section from unwanted displacement from the gravitational force exerted on the piston rod if a malfunction of the balancing displacement unit occurs. The safety brake arrangement is providing a safe system that stops the upper section with the labelling unit from further movement or from moving if in a standstill position. The safety brake arrangement may be arranged as a friction brake. A friction brake is an efficient and cost effective solution that gives good braking performance, where the locking position of the friction brake can be controlled in a stepless manner.

The disclosure further concerns a method for operating a safety labelling system, where the safety labelling system comprises a lifting device and a labelling unit. The lifting device is positioning the labelling unit in a vertical direction in relation to a flow of objects. The labelling unit is printing labels and/or applying labels to the objects. The lifting device comprises an upper section and a lower section. The upper section is movably arranged relative to the lower section by means of a balancing displacement unit arranged between the upper section and the lower section. The labelling unit is attached to the upper section. The balancing displacement unit comprises a cylinder barrel, a piston movably arranged in the cylinder barrel, a piston rod, and a cylinder nut. The piston rod and the cylinder nut are rotatably engaged with each other. The piston rod is at an inner end connected to the piston and the cylinder nut is connected to the cylinder barrel. The balancing displacement unit further comprises a load balancing pressure chamber arranged in the cylinder barrel in connection to the piston. The method comprises the steps: rotatably displacing the piston rod or the cylinder nut by means of an actuator, where the rotational displacement of the piston rod or the cylinder nut is resulting in linear displacement of the piston rod and the piston relative to the cylinder barrel for moving the upper section with the labelling unit in the vertical direction; counterbalancing a gravitational force exerted on the piston rod from the safety labelling system by applying a counterbalancing force onto the piston by means of fluid pressure in the load balancing pressure chamber.

Advantages with these features are that through the counterbalancing of the piston rod, the safety labelling system comprising the lifting device and the labelling unit can be operated in a safe manner with low forces acting on the actuator and the surrounding environment. Through the counterbalancing action, the load exerted on the actuator is low, and the labelling unit can be moved with high speed and positioned with high precision since the actuator is not used for moving heavy loads. The load balancing pressure chamber is counterbalancing the gravitational force exerted on the piston rod from the safety labelling system by applying the counterbalancing force onto the piston by means of fluid pressure in the load balancing pressure chamber. The load is in this way carried by the balancing displacement unit via the load balancing pressure chamber, and therefore a smaller drive unit controlled with high precision can be used. Further, the safety labelling system is providing a safe and simple labelling arrangement, where the labelling unit can be repositioned from one position to another with high speed and with high precision through the interaction between the actuator and the load balancing pressure chamber. Since a smaller drive unit can be used, the balancing displacement unit is further used for preventing unwanted displacement of the labelling unit in the downwards direction through the applied counterbalancing force onto the piston by means of fluid pressure in the load balancing pressure chamber. A smaller drive unit is providing a safer construction, since the force exerted on the piston rod from the safety labelling system is lower compared to traditional solutions that require more powerful drive units. A smaller drive unit gives in this way low impact forces in case the labelling unit or the upper section is interfering with persons or objects. The balancing displacement unit is connected to the movable section and arranged to interact with and support the actuator and counterbalancing the gravitational force exerted on the piston rod by the labelling unit, the movable section and other parts or components of the safety labelling system connected to the labelling unit and the upper section.

In one embodiment, the inner end of the piston rod is rotatably connected to the piston via a piston bearing unit. The cylinder nut is non-rotatably connected to the cylinder barrel. The actuator is connected to the piston rod. The method further comprises the step: rotating the piston rod around a rotational axis by the actuator for displacing the upper section with the labelling unit in the vertical direction. This arrangement is providing an efficient displacement of the labelling unit, where the rotation of the piston rod is transferred into a linear movement of the piston rod in the vertical direction. The piston rod is in this way displacing the upper section with the labelling unit vertically.

In one embodiment, the inner end of the piston rod is non-rotatably connected to the piston. The cylinder nut is rotatably connected to the cylinder barrel via a nut bearing unit. The actuator is connected to the cylinder nut. The method further comprises the step: rotating the cylinder nut around a rotational axis by the actuator for displacing the upper section with the labelling unit in the vertical direction. This arrangement is providing an efficient displacement of the labelling unit, where the rotation of the cylinder nut is transferred into a linear movement of the piston rod in the vertical direction. The piston rod is in this way displacing the upper section with the labelling unit vertically.

In one embodiment, the method further comprises the step: controlling the position of the labelling unit in the vertical direction in relation to the flow of objects by means of the actuator, by displacing the upper section in an upwards direction and/or a downwards direction to a labelling position of the labelling unit, where in the labelling position the labels are printed and/or applied to the objects.

In one embodiment, the load balancing pressure chamber is configured as a pneumatic cylinder chamber. The method further comprises the step: pressurizing the load balancing pressure chamber by means of compressed air from an air pressure source for establishing the counterbalancing force onto the piston for counterbalancing the gravitational force exerted on the piston rod. The pneumatic cylinder chamber provides an efficient and cost effective solution, where the pneumatic cylinder chamber can be efficiently controlled with valves and regulators to balance the gravitational force. The pneumatic cylinder chamber is further enabling a constant pneumatic force independent of the position of the piston, which pneumatic force also is possible to control in a stepless manner.

In one embodiment, the safety labelling system is provided with a safety brake arrangement. The method further comprises the step: preventing the upper section from unwanted displacement from the gravitational force exerted on the piston rod if a malfunction of the balancing displacement unit occurs by means of the safety brake arrangement. The safety brake arrangement is providing a safe system that stops the upper section with the labelling unit from further movement or from moving if in a standstill position. A friction brake is an efficient and cost effective solution that gives good braking performance, where the locking position of the friction brake can be controlled in a stepless manner.

### BRIEF DESCRIPTION OF DRAWINGS

The disclosure will be described in detail in the following, with reference to the attached drawings, in which

FIG. 1 shows schematically, in a perspective view, a safety labelling system and an object to be labelled,

FIG. 2a-b show schematically, in side views, the safety labelling system in a raised position and a lowered position, adapted to the size of the object,

FIG. 3a-b show schematically, in cross-sectional side views, the safety labelling system in a raised position and a lowered position, adapted to the height of a transporting unit,

FIG. 4a-b show schematically, in cross-sectional side views, an embodiment of the safety labelling system with a balancing displacement unit,

FIG. 5 shows schematically, in a cross-sectional side view, an embodiment of the balancing displacement unit of the safety labelling system, and

FIG. 6a-b show schematically, in cross-sectional side views, alternative embodiments of the balancing displacement unit of the safety labelling system.

### DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

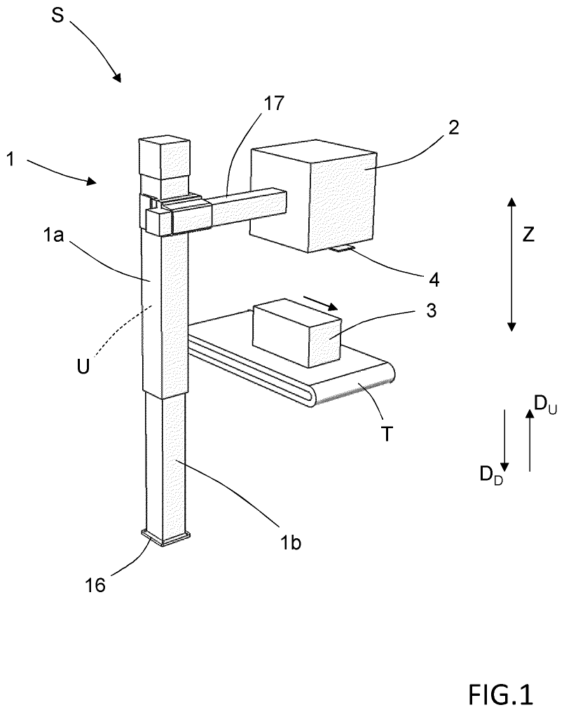

FIG. 1 schematically shows a safety labelling system S comprising a lifting device 1 and a labelling unit 2. The lifting device 1 is configured for positioning the labelling unit 2 in a vertical direction Z in relation to a flow of objects 3. The objects 3 may be of any type, and suitably, the objects 3 are transported past the safety labelling system S by means of a transporting unit T, such as a conveyor belt or similar transportation arrangement. The objects 3 could be any types of products or goods that should be labelled or marked, and typically, the objects 3 are in the form of boxes or pallets that are transported on the transporting unit T. The labelling unit 2 is arranged for printing labels 4 and/or applying labels 4 to the objects 3. It should be understood that in FIG. 1, only one object 3 is shown for illustrative purposes.

The lifting device 1 is arranged for positioning the labelling unit 2 in the vertical direction Z, in any desired position between a maximum position and a minimum position of the lifting device 1 in the vertical direction Z, and the limiting maximum and minimum positions may vary depending on the construction and design of the lifting device 1.

The labelling unit 2 may be any suitable type of labelling device. The labelling unit 2 can for example be an applicator unit that is applying pre-printed labels on the objects 3. The labelling unit 2 may also be arranged as a print and apply unit, where the labelling unit 2 comprises a printer unit for printing the labels and an applicator unit that is transporting the labels 4 from the printer to the objects 3 and further applying the labels 4 on the objects 3. The labels 4 can for example be transported to and applied to the objects with movable arms or with a belt system. The labelling unit 2 may also be a printer unit that is printing labels 4 to an applicator unit arranged separately from the labelling unit 2.

The labels 4 could be of any suitable type, and as described above, the labels 4 may be pre-printed or printed in the printing unit of the labelling unit 2. Commonly, self-adhesive labels are used, where the labels in a conventional way are provided with an adhesive layer on one side and carried by a paper web or similar structure that is holding the labels spaced apart. Other types of labels that may be used are for example so called linerless labels without carrying web, where the labels are printed from a continuous label structure and then cut into a desired size.

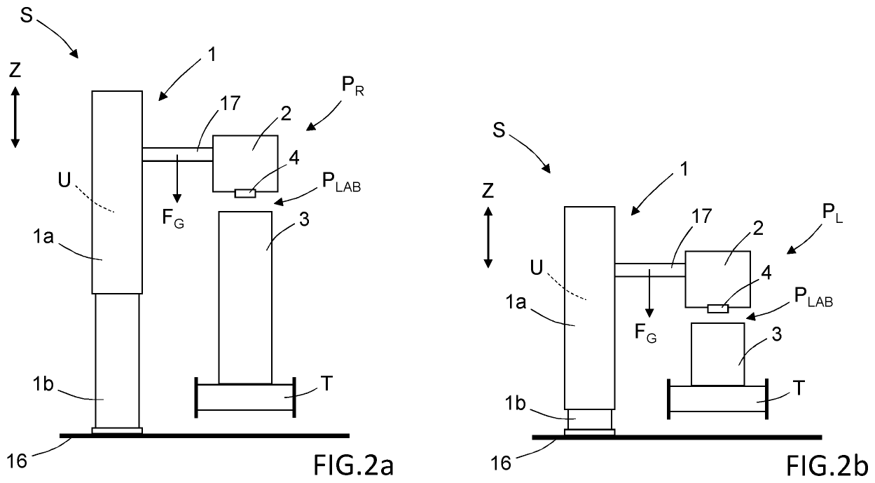

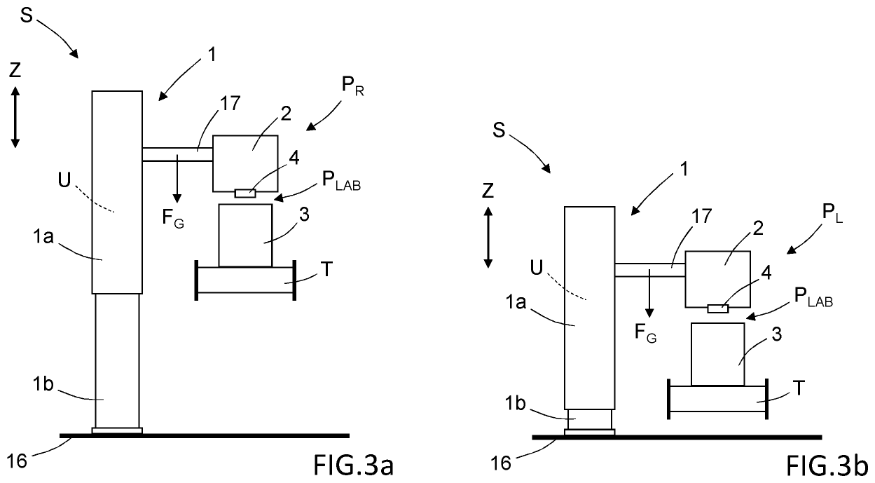

The objects 3 that are travelling past the safety labelling system S may vary in size and shape. Therefore, the position of the labelling unit 2 needs to be altered depending on the configuration of the objects 3, as illustrated in FIGS. 2a and 2b. In FIG. 2a, the safety labelling system S is arranged in a raised position P_{R} adapted to the height of the object 3. In FIG. 2b, the safety labelling system is arranged in a lowered position P_{L} adapted to the height of the object 3. Further, the lifting device 1 may be used for transporting units T arranged on different heights, or the transporting unit T may be arranged to be repositioned in the vertical direction Z and therefore the position of the labelling unit 2 needs to be altered depending on the position of the transporting unit T, as illustrated in FIGS. 3a and 3b. In FIG. 3a, the safety labelling system S is arranged in a raised position P_{R} adapted to the height of transporting unit T. In FIG. 3b, the safety labelling system is arranged in a lowered position P_{L} adapted to the height of the transporting unit T.

The transporting unit T is often placed in a position below or besides the labelling unit 2 and to achieve a correct labelling position P_{LAB} of the labelling unit 2 in relation to the objects 3, the lifting device 1 is adjustable in the vertical direction Z. The correct labelling position P_{LAB} may vary depending on the type of objects 3 and also on which side or end of the objects 3 the labels 4 are applied. The labelling position P_{LAB} can be manually determined by an operator or automatically by a sensor unit connected to the labelling unit 2. In the illustrated embodiments, the labels 4 are applied on an upper surface of the objects 3 for illustrative purposes. It should however be understood that the labelling unit 2 could have any suitable configuration and the labels 4 may be applied to any suitable position on the objects 3, such as an upper surface of the objects 3, a lower surface of the objects 3, or any of the side surfaces of the objects 3.

The lifting device 1 comprises an upper section 1a and a lower section 1b, and the upper section 1a is movably arranged relative to the lower section 1b by means of a balancing displacement unit U arranged between the upper section 1a and the lower section 1b, as will be further described below. Suitably, the upper section 1a and the lower section 1b are arranged relative to each other with overlapping relationships for a telescopic configuration of the lifting device 1, as understood from the figures. The lifting device 1 is in this way extendable and retractable in the vertical direction Z through a sliding movement between the upper section 1a and the lower section 1b. A drive unit arranged as an actuator M is connected to the balancing displacement unit U for the displacement of the upper section 1a relative to the lower section 1b in the vertical direction Z.

In the illustrated embodiments, the balancing displacement unit U is arranged inside the upper section 1a and the lower section 1b for a compact design of the lifting device 1. The labelling unit 2 is attached to the upper section 1a.

The lifting device 1 is arranged to control the position of the labelling unit 2 in the vertical direction Z in relation to the flow of objects 3. The position of the labelling unit 2 in the vertical direction Z is thus controlled through displacing the upper section 1a in the vertical direction Z. The labelling unit 2 is connected to the upper section 1a, and a repositioning of the upper section 1a relative to the lower section 1b in the vertical direction Z will result in a repositioning of the labelling unit 2 in the vertical direction Z. Thus, by displacing the upper section 1a in the vertical direction Z, the position of the labelling unit 2 can be altered into the desired labelling position P_{LAB}. The labelling position P_{LAB} is a position suitable for the printing of labels and/or the application of labels 4 on the objects 3, and as described above, the correct labelling position P_{LAB} may vary depending on the type of objects 3, and on which side or end of the objects 3 the labels 4 are applied. The lifting device 1 is constructed for displacement of the upper section 1a with the labelling unit 2 both in an upwards direction D_{U} and in a downwards direction D_{D} to the labelling position P_{LAB} of the labelling unit 2, where in the labelling position P_{LAB} the labels 4 are printed and/or applied to the objects 3. The displacement of the lifting device 1 in the upwards direction D_{U} or the downwards direction D_{D} to the correct labelling position P_{LAB} can be manually controlled by an operator, or automatically controlled by a suitable sensor system arranged in connection to the lifting device 1, the labelling unit 2, or arranged as a separate unit. The lifting device 1 may be arranged with a control panel or other control arrangements to steer the movement of the lifting device 1 when operated manually.

As shown in for example FIGS. 1, 2a-b, 3a-b and 4a-b, the lower section 1b of the lifting device is arranged on a support surface 16, such as a floor surface. The lower section 1b is attached to the support surface 16 in any suitable way. The lower stand unit 16 may be provided with a base plate or similar structure that is attaching a lower part of the lower section 1b to the support surface 16 with bolts, screws or other suitable fastening means, and through the attachment to the support surface 16 the lower section 1b is providing a stable and reliable support structure for the lifting device 1 and the labelling unit 2.

The labelling unit 2 may be attached to the upper section 1a in any suitable way. In the embodiment shown in the figures, the labelling unit 2 is connected to the upper section 1a via at least one support arm 17. An inner end of the support arm 17 is attached to the upper section 1a with for example a holder bracket or similar arrangement, and an outer end of the support arm 17 is attached to the labelling unit 2. The outer end of the support arm 17 may be attached to the labelling unit 2 with for example a holder bracket or similar structural arrangement. The support arm 17 may if desired be arranged in different positions in the vertical direction on the upper stand unit 17 and on different sides of the upper stand unit 17.

The support arm 17 has an elongated shape in the shown embodiment, but the support arm 17 may have any suitable shape depending on the construction and design of the lifting device 1 and the labelling unit 2. The support arm 17 may have different dimensions depending on the specific labelling application, and be made in one or several constructional parts. The support arm 17 may for example have a square hollow or tubular configuration with an essentially square or circular cross-sectional shape. However, other suitable cross-sectional shapes are also possible if desired. The support arm can be made of any suitable material, such as for example aluminium, steel, plastic materials, composite materials, or of combinations of different materials.

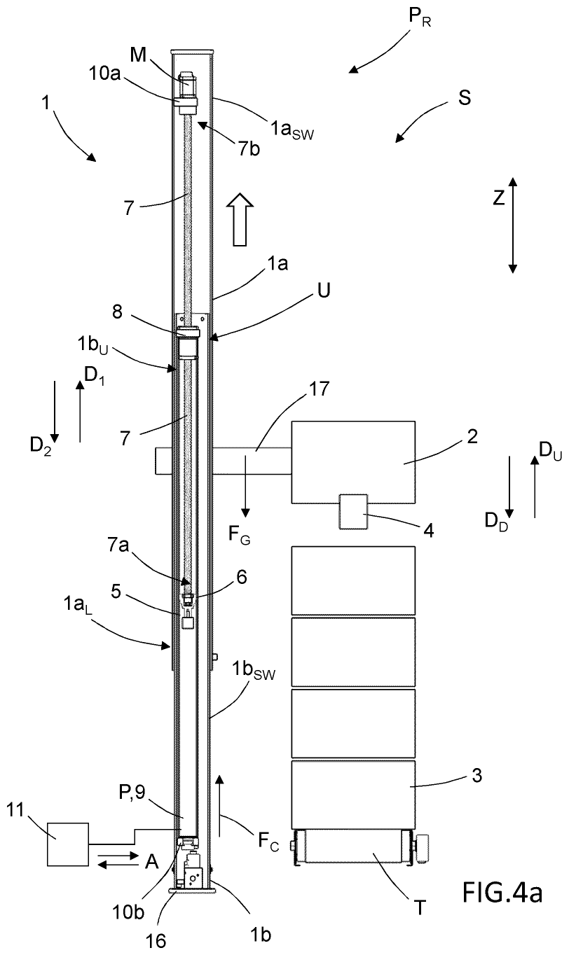

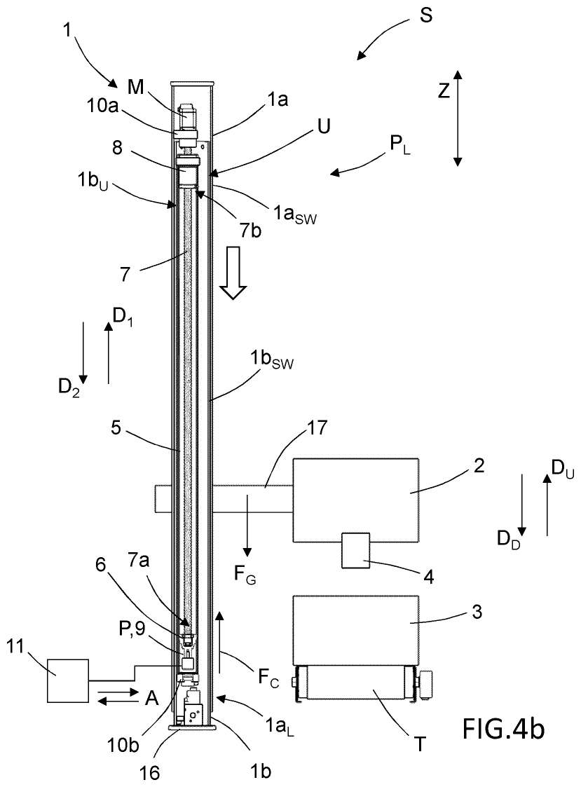

As shown in the figures, the upper section 1a and the lower section 1b have elongated shapes with extensions in the vertical direction Z. The upper section 1a is movably arranged in relation to the lower section 1b in the vertical direction Z. The upper section 1a and the lower section 1b are telescopically arranged relative to each other, and the upper section 1a is moving in an overlapping relationship in the vertical direction Z outside the lower section 1b. In this way, at least a lower part 1a_{L} of the upper section 1a is encompassing at least an upper part 1b_{U} of the lower section 1b, depending on the position of the upper section 1a in relation to the lower section 1b in the vertical direction Z, as shown in FIGS. 4a-b. In the illustrated embodiment, the upper section 1a thus has a telescopic configuration where side walls 1a_{sw} of the upper section 1a are arranged on the outside of side walls 1b_{SW} of the lower section 1b.

To ensure that the upper section 1a is moving in the vertical direction Z without movements in other directions, one or more slide bushings may be arranged between the upper section 1a and the lower section 1b. The slide bushings can be arranged as one or more collars between the upper section 1a and the lower section 1b, or as discrete pieces of material arranged between the upper section 1a and the lower section 1b. The slide bushings are configured for allowing the upper section 1a to move in the vertical direction Z in relation to the lower section 1b with low friction and at the same time ensuring that any play between the upper section 1a and the lower section 1b is minimized, preventing movements in other directions. The slide bushings can be made of any suitable material, such as for example plastic materials, composite materials, rubber materials or metals. The upper section 1a and the lower section 1b can have corresponding cross-sectional profiles, such as square, rectangular, circular, or other suitable shapes. In the embodiment shown in the figures, the upper section 1a and the lower section 1b have corresponding essentially square cross-sectional profiles when viewed from above. It should be understood that in alternative non-illustrated embodiments, the upper section 1a instead may be arranged inside the lower section 1b in an overlapping configuration. The upper section 1a and the lower section 1b can be made of any suitable material, such as for example aluminium, steel, plastic materials, composite materials, or of combinations of different materials.

As shown in FIGS. 4a-b and 5, the upper section 1a comprises an upper support bracket 10a arranged for attaching the balancing displacement unit U to the upper section 1a. The upper support bracket 10a may be arranged as an integrated or attached constructional part of the upper section 1a. Suitably, the upper support bracket 10a may be arranged as a plate or similar structure arranged inside the upper section 1a to which the different components of the lifting device 1 can be attached. The upper support bracket 10a can be made of any suitable material, such as for example aluminium, steel, plastic materials, composite materials, or of combinations of different materials.

As shown in FIGS. 4a-b and 5, the lower section 1b comprises a lower support bracket 10b arranged for attaching the balancing displacement unit U to the lower section 1b. The lower support bracket 10b may be arranged as an integrated or attached constructional part of the lower section 1b. Suitably, the lower support bracket 10b may be arranged as a plate or similar structure arranged inside the lower section 1b to which the different components of the lifting device 1 can be attached. The lower support bracket 10b can be made of any suitable material, such as for example aluminium, steel, plastic materials, composite materials, or of combinations of different materials.

Through the arrangement with the upper support bracket 10a and the lower support bracket 10b, the balancing displacement unit U is arranged to interact with and be connected to the upper section 1a and the lower section 1b respectively, for an efficient displacement of the upper section 1a relative to the lower section 1b.

The balancing displacement unit U is, as described above, connected to the upper support bracket 10a of the upper section 1a, and connected to the lower support bracket 10b of the lower section 1b. The balancing displacement unit U is through this construction arranged inside the upper section 1a and the lower section 1b for a compact design of the lifting device 1. The balancing displacement unit U is used for displacing the upper section 1a in the upwards direction D_{U} and the downwards direction D_{D} for positioning the labelling unit 2 in the correct labelling position P_{LAB}. The balancing displacement unit U is further counterbalancing forces exerted from the labelling unit 2 and the lifting device 1 for a safe construction of the safety labelling system S, as will be further described below.

An embodiment of the balancing displacement unit U is illustrated in FIGS. 4a-b and 5. The balancing displacement unit U comprises a cylinder barrel 5 and a piston 6 movably arranged in the cylinder barrel 5. A piston rod 7 is at an inner end 7a connected to the piston 6, and a cylinder nut 8 is connected to the cylinder barrel 5. The piston rod 7 and the cylinder nut 8 are rotatably engaged with each other for displacement of the piston rod 7 with the piston 6 relative to the cylinder barrel 5. Suitably, the piston rod 7 is configured as a ball screw and the cylinder nut 8 is configured as a ball nut. The ball screw and ball nut arrangement may be of any suitable type. The piston rod 7 arranged as a ball screw is arranged with threads providing a helical raceway for ball bearings or a ball assembly arranged in the ball nut. When the ball screw is rotating, the ball nut travels along the ball screw, and depending on the rotational direction of the ball screw, the ball nut can travel in opposite directions along the ball screw. The pitch of the helical raceway is determining the ratio between the rotating piston rod 7 and the linear movement of the piston rod 7 relative to the ball nut, and therefore a suitable pitch and drive speed is determined when designing the system. Alternatively, the piston rod 7 is configured as a threaded screw and the cylinder nut 8 is configured as a threaded nut.

In the embodiment shown in FIGS. 4a-b and 5, the cylinder nut 8 is non-rotatably connected to the cylinder barrel 5 and the piston rod 7 is rotatably connected to the piston 6. An outer end 7b of the piston rod 7 is connected to the upper section 1a of the lifting device 1, and the cylinder barrel 5 is connected to the lower section 1b. Suitably, the outer end 7b of the piston rod 7 is connected to the upper support bracket 10a and the cylinder barrel 5 is connected to the lower support bracket 10b.

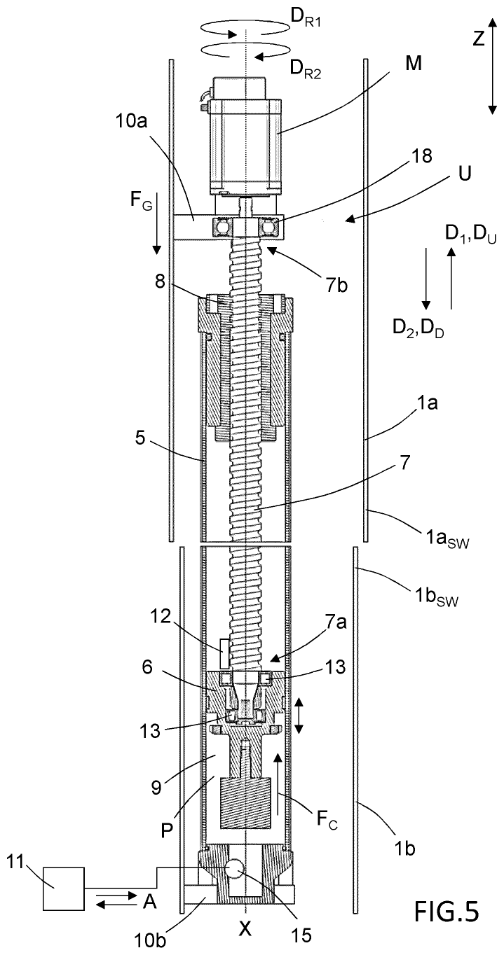

By rotating the piston rod 7 in a first rotational direction D_{R1} around a rotational axis X, as shown in FIG. 5, the piston rod 7 with the piston 6 is linearly displaced in a first direction D₁ relative to the cylinder barrel 5 through the engagement between the piston rod 7 and the cylinder nut 8, and the piston rod 7 is in this way displaced out from the cylinder barrel 5, as indicated in FIGS. 5 and 4a. It should be understood that the piston 6 is linearly displaced with the piston rod 7 in the first direction D₁ due to the connection of the piston rod 7 to the piston 6. The first direction D₁ is in the shown embodiment corresponding to the upwards direction D_{U}. Due to the further connection between the piston rod 7 and the upper section 1a, the upper section 1a with the labelling unit 2 is displaced in the upwards direction D_{U}, when the piston rod 7 is rotated in the first rotational direction DR₁ around the rotational axis X, as indicated with the arrow in FIGS. 4a-b.

By rotating the piston rod 7 in a second rotational direction D_{R2} around the rotational axis X, the piston rod 7 with the piston 6 is linearly displaced in a second direction D₂ relative to the cylinder barrel 5 through the engagement between the piston rod 7 and the cylinder nut 8, and the piston rod 7 is in this way displaced into the cylinder barrel 5, as understood from FIG. 4b. The second rotational direction D_{R2} is opposite the first rotational direction DR₁. It should be understood that the piston 6 is linearly displaced with the piston rod 7 in the second direction D₂ due to the connection of the piston rod 7 to the piston 6. The second direction D₂ is in the shown embodiment corresponding to the downwards direction D_{D}. Due to the further connection between the piston rod 7 and the upper section 1a, the upper section 1a with the labelling unit 2 is displaced in the downwards direction D_{D}, when the piston rod 7 is rotated in the second rotational direction D_{R2} around the rotational axis X, as indicated with the arrow in FIGS. 4a-b.

An actuator M is drivingly connected to the piston rod 7 and configured for rotating the piston rod 7 around the rotational axis X. The actuator M is rotatably displacing the piston rod 7 in the first rotational direction D_{R1} and the second rotational direction D_{R2} respectively. As described above, the rotational displacement of the piston rod 7 is through the engagement between the piston rod 7 and the cylinder nut 8 resulting in linear displacement of the piston rod 7 and the piston 6 relative to the cylinder barrel 5 for moving the upper section 1a with the labelling unit 2 in the vertical direction Z. The actuator M is in this way upon actuation displacing the upper section 1a with the labelling unit 2 in the vertical direction Z. As shown in FIGS. 4a-b and 5, the actuator M is arranged inside the space formed by the upper section 1a and the lower section 1b. The actuator M can be designed as a variable speed drive unit for controlling the speed of the labelling unit 2 displacement in the vertical direction Z.

The actuator M may be of any suitable type, such as for example an electric motor. The type of electric motor can be chosen to fit the specific design of the lifting device 1. In order to control the displacement of the labelling unit 2 in the vertical direction Z with high precision, the actuator M is suitably arranged as a stepper motor adapted for rotatably positioning the piston rod 7 with high precision. The stepper motor can be controlled by a control unit to secure the displacement of the upper section 1a in relation to the lower section 1b with high precision, where the stepper motor with high accuracy in a stepwise manner is rotating the piston rod 7 into a desired rotational position. Since the stepper motor can be controlled with incremental steps, the positioning of the labelling unit 2 can be made with high precision compared to traditional high power electric motors normally used in lifting devices.

Suitably, the inner end 7a of the piston rod 7 is rotatably connected to the piston 6 via one or more piston bearing units 13. A bracket bearing 18 may be used for rotatably connecting the outer end 7b of the piston rod 7 to the upper support bracket 10a.

The actuator M is used for controlling the position of the labelling unit 2 in the vertical direction Z in relation to the flow of objects 3 through displacing the upper section 1a in the upwards direction D_{U} and in the downwards direction D_{D} to the labelling position P_{LAB} Of the labelling unit 2. In the labelling position P_{LAB}, the labels 4 are printed and/or applied to the objects 3.

The actuator M is in the embodiment shown in FIGS. 4a-b and 5 directly connected to the piston rod 7. Alternatively, the actuator M is indirectly connected to the piston rod 5 via a gear unit or similar arrangement. The gear unit may be part of the upper section 1a and may be of any conventional type, such as for example a belt drive unit or a toothed gear unit.

As shown in FIGS. 4a-b and 5, the balancing displacement unit U further comprises a load balancing pressure chamber 9 arranged in the cylinder barrel 5. The load balancing pressure chamber 9 is positioned in connection to the piston 6, and as understood from the figures, the load balancing pressure chamber 9 is delimited by the cylinder barrel 5 and the piston 6. The load balancing pressure chamber 9 is configured for counterbalancing a gravitational force F_{G} exerted on the piston rod 7 from the safety labelling system S by applying a counterbalancing force F_{C} onto the piston 6 by means of fluid pressure P in the load balancing pressure chamber 9.

As described above, the labelling unit 2 is connected to the upper section 1a, and the upper section 1a is connected to the outer end 7b of the piston rod 7. Through this arrangement, the parts of the safety labelling system S formed by the labelling unit 2, the upper section 1a, and other parts or components of the safety labelling system S connected to the labelling unit 2 and the upper section 1a, are exerting the gravitational force F_{G} onto the piston rod 7.

The load balancing pressure chamber 9 is forming part of the balancing displacement unit 9 and is arranged to interact with the lifting device 1. The load balancing pressure chamber 9 is supporting the actuator M by counterbalancing the gravitational force F_{G} exerted on the exerted on the piston rod 7 from the safety labelling system S, and through this counterbalancing action, the load exerted on the actuator M is decreased. The load balancing pressure chamber 9 is further preventing unwanted displacement of the labelling unit 2 in the downwards direction D_{D} by the fluid pressure P. The load balancing pressure chamber 9 is designed to exert a pushing force onto the piston 6 in the upwards direction D_{U} with the counterbalancing force F_{C} corresponding to the gravitational force F_{G} exerted on the safety labelling system S.

Through the counterbalancing action by the load balancing pressure chamber 9 the load exerted on the actuator M is low, and the labelling unit 2 can be moved by the actuator M through displacement of the piston rod 7 with high speed. Further, the labelling unit 2 can be positioned with high precision since the actuator M is not used for moving heavy loads. The load is instead carried by the load balancing pressure chamber 9 through the counterbalancing action and therefore a small actuator M that can be controlled with high precision can be used. The labelling unit 2 can be repositioned from one position to another with high speed and with high precision through the interaction between the actuator M for displacing the piston rod 7 and the load balancing pressure chamber 9. Since a smaller actuator M can be used, the load balancing pressure chamber 9 is further used for preventing unwanted displacement of the labelling unit 2 in the downwards direction D_{D}. A smaller actuator M is providing a safer construction, since the force exerted on the upper section 1a during movement is low, which gives low impact forces in case the labelling unit 2 or the upper section 1a is interfering with persons or objects.

The load balancing pressure chamber 9 may be of any suitable type, and in the embodiment shown in the figures, the load balancing pressure chamber 9 is arranged as a pneumatic actuator. The load balancing pressure chamber 9 is suitably configured as a pneumatic cylinder chamber, where the load balancing pressure chamber 9 is pressurized by means of compressed air A from an air pressure source 11 for establishing the counterbalancing force F_{C} onto the piston 6 for counterbalancing the gravitational force F_{G} exerted on the piston rod 7.

The load balancing pressure chamber 9 is thus applying a pneumatic force that is counterbalancing the gravitational force F_{G} exerted on the piston rod 7. The load balancing pressure chamber 9 may also be used for supporting the actuator M during displacement of the labelling unit 2 in the upwards direction D_{U}, where the applied pneumatic force during the displacement sequence is higher than the gravitational force F_{G}.

Air is allowed to flow into our out from the load balancing pressure chamber 9 through one or more flow ports connected to the air pressure source 11, depending on the movement of the piston 6 with the piston rod 7 relative to the cylinder barrel 5, and depending on the fluid pressure P in the load balancing pressure chamber 9. In the embodiment shown in FIGS. 4a-b and 5, the load balancing pressure chamber 9 has a flow port 15 arranged in a lower end of the cylinder barrel 5. Compressed air A is thus allowed to flow into and out from the flow port 15, for establishing the fluid pressure P in the load balancing pressure chamber 9 and for exerting the counterbalancing force F_{C} onto the piston rod 7. The amount of compressed air A flowing into and out from the load balancing pressure chamber 9 via the flow port 15 is suitably controlled by a control unit for controlling the fluid pressure P in the load balancing pressure chamber 9 depending on the position of the labelling unit 2 in the vertical direction Z and the gravitational force F_{G} exerted on the piston rod 7.

When the labelling unit 2 is arranged in a standstill position in the vertical direction Z, the fluid pressure P in the load balancing pressure chamber 9 is maintained to counterbalance the gravitational force F_{G} exerted on the piston rod 7 from the safety labelling system S by applying the counterbalancing force F_{C} onto the piston 6 by means of the fluid pressure P in the load balancing pressure chamber 9.

When displacing the labelling unit 2 in the upwards direction D_{U} by means of the actuator M, compressed air A is allowed to flow into the load balancing pressure chamber 9 via the flow port 15 to maintain the fluid pressure P and the counterbalancing force F_{C}. In this way, the fluid pressure P in the load balancing pressure chamber 9 is maintained upon movement of the piston 6 and the piston rod 7 in the upwards direction D_{U} and the gravitational force F_{G} exerted on the piston rod 7 from the safety labelling system S is counterbalanced by applying the counterbalancing force F_{C} onto the piston 6 by means of the fluid pressure P in the load balancing pressure chamber 9. The fluid pressure P in the load balancing pressure chamber 9 may be even further increased to support the displacement of the piston rod 7 in the upwards direction D_{U}.

When displacing the labelling unit 2 in the downwards direction D_{D} by means of the actuator M, compressed air A is allowed to flow out from the load balancing pressure chamber 9 via the flow port 15 to maintain the fluid pressure P and the counterbalancing force F_{C}. In this way, the fluid pressure P in the load balancing pressure chamber 9 is maintained upon movement of the piston 6 and the piston rod 7 in the downwards direction D_{D} and the gravitational force F_{G} exerted on the piston rod 7 from the safety labelling system S is counterbalanced by applying the counterbalancing force F_{C} onto the piston 6 by means of the fluid pressure P in the load balancing pressure chamber 9.

Valves and suitable pneumatic regulators are used for controlling the air flow and pressure level into and out from the load balancing pressure chamber 9 upon movement of the piston 6 with the piston rod 7 in the upwards and downwards directions respectively.

When the counterbalancing force F_{C} by means of the fluid pressure P in the load balancing pressure chamber 9 is maintained equal to the gravitational force F_{G}, the lifting device 1 is fully balanced and in this way the actuator M can be used for positioning the upper section 1a with the labelling unit 2 without any need for displacing the load of the upper section 1a and the labelling unit 2. Since the system is balanced through load balancing pressure chamber 9, a small electric motor with high precision, such as the stepper motor described above, can be used as the actuator M to position the labelling unit 2 in the correct labelling position P_{LAB}. Through the fluid pressure P, a safe system is achieved where the counterbalancing force F_{C} is preventing high loads on the actuator and unwanted displacement of the labelling unit 2 in the downwards direction D_{D}.

The actuator M and the load balancing pressure chamber 9 may be connected to a control unit that is controlling the position of the labelling unit 2 in the vertical direction Z through steering the actuator M and the load balancing pressure chamber 9 with high precision. When repositioning the labelling unit 2 in the vertical direction Z from one labelling position to another labelling position, the actuator M is used for rotating the piston rod 7 so that the labelling unit 2 is positioned in the correct labelling position P_{LAB}. During the repositioning of the labelling unit 2, the load balancing pressure chamber 9 is controlled so that the counterbalancing force F_{P} is maintained when the labelling unit 2 is moving in the upwards direction D_{U} or in the downwards direction D_{D}. The load balancing pressure chamber 9 can for example be provided with regulators that are controlling the pneumatic pressure so that the correct counterbalancing force F_{C} is applied to the piston rod 7. When attaching the labelling unit 2 to the lifting device 1, the system needs to be calibrated. To calibrate the system, a pneumatic force corresponding to the gravitational force F_{G} is applied. This calibrating operation may for example be performed when the lifting device 1 is in its lowest position, and by applying an increasing pneumatic force in the load balancing pressure chamber 9. When a pneumatic force equal to the gravitational force F_{G} is applied to the piston rod 7, the system starts to move in the upwards direction D_{U} and a pressure sensor could be used for measuring the pressure level in the load balancing pressure chamber 9 at the point where the system starts to move to find the correct counterbalancing force F_{C}. To detect when the system starts to move a position sensor may be used. As an alternative, the actuator M, such as the stepper motor with an encoder, can be used for detecting the movement of the system. The position sensor can further be used for positioning the labelling unit in the vertical direction Z, and the position sensor can for example be arranged inside the movable upper section 1a. The position sensor can be any type of suitable position sensor known in the art, such as a laser position sensor, an ultrasonic position sensor or an optical position sensor.

If using the stepper motor as the actuator M, the encoder can be used to monitor the rotational position of a shaft of the stepper motor. The encoder can also be used to identify if the lifting device 1 is blocked by an object or a person, wherein the stepper motor is prevented from further rotation. If the stepper motor is prevented from rotating, a signal could be sent to the control unit, and in this way the system can be stopped to prevent accidents or damages to the system. The encoder may also be arranged on the piston rod 7 if desired.

Through the balancing of the system with the load balancing pressure chamber 9 and the use of a stepper motor as the actuator M, the labelling unit 2 can be positioned with high precision. The load balancing pressure chamber 9 is relieving the forces on the actuator M, and in this way the drive unit is not used for moving heavy loads. The design with interacting actuator M and load balancing pressure chamber 9 is providing a safe and simple construction, where the labelling unit 2 can be repositioned with high speed and with high precision. The balancing of the piston rod 7 is used for preventing unwanted displacement of the labelling unit 2 in the downwards direction D_{D}, and through the prevention of unwanted displacement of the labelling unit 2 by the load balancing pressure chamber 9 in the downwards direction D_{D} a safe construction is achieved. Since the system is balanced by the load balancing pressure chamber 9, the actuator M when arranged as a stepper motor can be used in a continuous drive mode also for heavy loads.

The safety labelling system S may be provided with an additional safety brake arrangement 12 configured to prevent the upper section 1a from unwanted displacement from the gravitational force F_{G} exerted on the piston rod 7 if a malfunction of the balancing displacement unit U occurs. The safety brake arrangement 12 is used for preventing the upper section 1a with the labelling unit 2 from unwanted displacement in the downwards direction D_{D} if a malfunction of the actuator M occurs or if a malfunction of the load balancing pressure chamber 9 occurs. The safety brake arrangement 12 is designed for activation when needed independent of the position of the parts of balancing displacement unit U, and the safety brake arrangement 12 may also be activated during movement of the system to prevent further movements of the system. As an example, a traditional friction brake system with a solenoid connected to a pressure sensor can be arranged to interact with a movable part, such as the piston rod 7 of the balancing displacement unit U. When a malfunction is occurring, such as a power failure, a breakdown of the actuator M, or a pressure drop in the load balancing pressure chamber 9, the friction brake system prevents the piston rod 7 from moving. In an alternative embodiment, the safety brake arrangement 12 can be a pneumatic system, where the friction brake system is controlled by a valve connected to the air pressure source 11. As long as the compressed air is supplied to the valve, the brake is inactivated. If a malfunction of the pneumatic system occurs, or if the air pressure source 11 is disconnected from the pneumatic cylinder chamber, so that no air is supplied to the valve, the brake will be automatically activated to prevent further movement of the piston rod 7. The air pressure source 1 when arranged as a pneumatic system may be connected to the safety brake arrangement 12 via a hose, pipe or other suitable means.

In other embodiments, the safety brake arrangement 12 may also be configured for preventing movement in the upwards direction D_{U}, thus preventing unwanted movements in both the downwards direction D_{D} and the upwards direction D_{U} upon malfunction.

It should be understood that suitable cables or hoses are used for supplying electricity and compressed air to the lifting device 1, and for powering the labelling unit 2. The cables or hoses can be arranged inside the lifting device 1 and/or on the outside depending on the constructional design. The cables and hoses may for example be guided during movement of the lifting device in a traditional way with movable cable carriers. The control unit may be positioned on or inside the lifting device, or alternatively arranged as a separate unit.

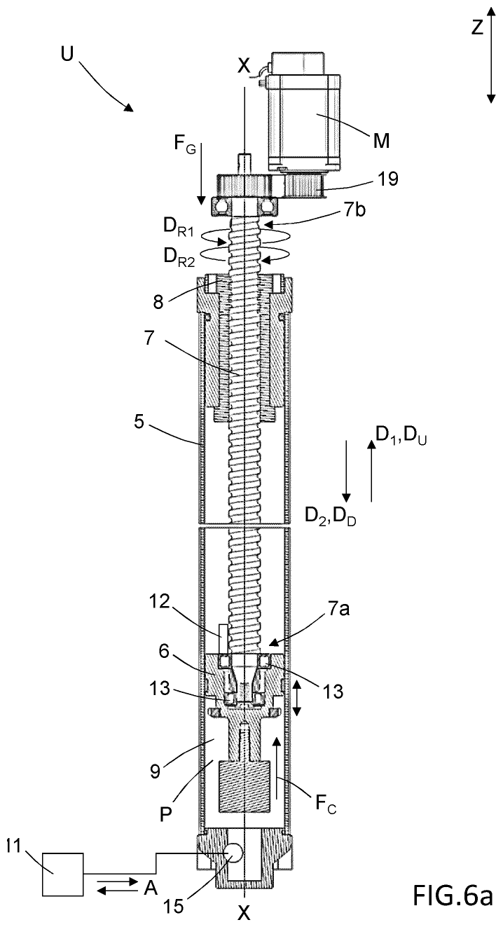

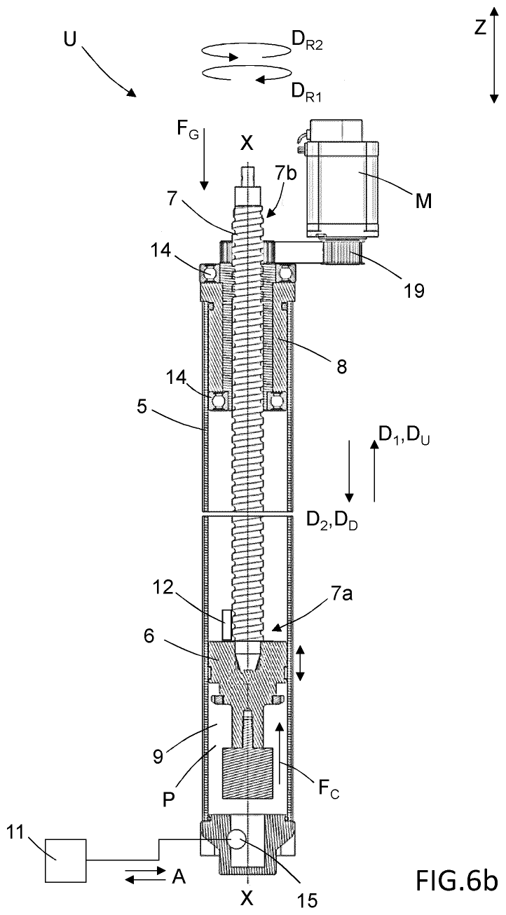

In FIG. 6a, an alternative embodiment of a balancing displacement unit U of a safety labelling system S is shown. In this embodiment, the actuator M is indirectly connected to the piston rod 7 via a belt drive arrangement 19. Other components and functions of the safety labelling system S and the balancing displacement unit U may be the same as or similar to the ones described in the embodiment above in connection to FIGS. 4a-b and 5.

The actuator M in the embodiment shown in FIG. 6a is transferring a rotational movement to the piston rod 7 via the belt drive arrangement 19. The actuator M is in this way drivingly connected to the piston rod 7 and configured for rotating the piston rod 7 around the rotational axis X. The actuator M is rotatably displacing the piston rod 7 in the first rotational direction D_{R1} and the second rotational direction D_{R2} respectively. The rotational displacement of the piston rod 7 is through the engagement between the piston rod 7 and the cylinder nut 8 resulting in linear displacement of the piston rod 7 and the piston 6 relative to the cylinder barrel 5 for moving the upper section 1a with the labelling unit 2 in the vertical direction Z. The actuator M is in this way upon actuation displacing the upper section 1a with the labelling unit 2 in the vertical direction Z. As shown in FIG. 6a, the actuator M is arranged inside the space formed by the upper section 1a and the lower section 1b. The actuator M can be designed as a variable speed drive unit for controlling the speed of the labelling unit 2 displacement in the vertical direction Z.

The actuator M may be of any suitable type, such as for example an electric motor. The type of electric motor can be chosen to fit the specific design of the lifting device 1. In order to control the displacement of the labelling unit 2 in the vertical direction Z with high precision, the actuator M is suitably arranged as a stepper motor adapted for rotatably positioning the piston rod 7 with high precision. The stepper motor can be controlled by a control unit to secure the displacement of the upper section 1a in relation to the lower section 1b with high precision, where the stepper motor with high accuracy in a stepwise manner is rotating the piston rod 7 into a desired rotational position. Since the stepper motor can be controlled with incremental steps, the positioning of the labelling unit 2 can be made with high precision compared to traditional high power electric motors normally used in lifting devices.

The actuator M is used for controlling the position of the labelling unit 2 in the vertical direction Z in relation to the flow of objects 3 through displacing the upper section 1a in the upwards direction D_{U} and in the downwards direction D_{D} to the labelling position P_{LAB} Of the labelling unit 2. In the labelling position P_{LAB}, the labels 4 are printed and/or applied to the objects 3.

A further alternative embodiment of a balancing displacement unit U of a safety labelling system S is schematically illustrated in FIG. 6b. Instead of rotatably displacing a piston rod 7 as described in the embodiments above, an actuator M is rotatably displacing a cylinder nut 8.

The balancing displacement unit U comprises a cylinder barrel 5 and a piston 6 movably arranged in the cylinder barrel 5. The piston rod 7 is at an inner end 7a connected to the piston 6, and the cylinder nut 8 is connected to the cylinder barrel 5. The cylinder nut 8 and the piston rod 7 are rotatably engaged with each other for displacement of the piston rod 7 with the piston 6 relative to the cylinder barrel 5. Suitably, the piston rod 7 is configured as a ball screw and the cylinder nut 8 is configured as a ball nut. The ball screw and ball nut arrangement may be of any suitable type. The piston rod 7 arranged as a ball screw is arranged with threads providing a helical raceway for ball bearings or a ball assembly arranged in the ball nut. When the ball screw is rotating the ball nut travels along the ball screw, and depending on the rotational direction of the ball screw, the ball nut can travel in opposite directions along the ball screw. The pitch of the helical raceway is determining the ratio between the rotating piston rod 7 and the linear movement of the piston rod 7 relative to the ball nut, and therefore a suitable pitch and drive speed is determined when designing the system. Alternatively, the cylinder nut 8 is configured as a threaded nut and the piston rod 7 is configured as a threaded screw.

The rotatable displacement of the cylinder nut 8 is resulting in linear displacement of the piston rod 7 and the piston 6 relative to the cylinder barrel 5 for moving an upper section 1a with a labelling unit 2 in a vertical direction Z.

In the embodiment shown in FIG. 6b, an inner end 7a of the piston rod 7 is non-rotatably connected to the piston 6, and the cylinder nut 8 is rotatably connected to the cylinder barrel 5 via one or more nut bearing units 14. An actuator M is connected to the cylinder nut 8 and configured for rotating the cylinder nut 8 around a rotational axis X upon actuation, for displacement of the upper section 1a with the labelling unit 2 in the vertical direction Z. In order to control the displacement of the labelling unit 2 in the vertical direction Z with high precision, the actuator M is suitably arranged as a stepper motor adapted for rotatably positioning the cylinder nut 8 with high precision, in the same way as described above.

Other components and functions of the safety labelling system S may be the same as or similar to the ones described in the embodiment above in connection to FIGS. 4a-b and 5. As understood from FIG. 6b, the balancing displacement unit U further comprises a load balancing pressure chamber 9 having the same configuration and function as described in the embodiments above.

The actuator M in the embodiment shown in FIG. 6b is transferring a rotational movement to the cylinder nut 8 via a belt drive arrangement 19, or similar arrangement such as gears. The actuator M is drivingly connected to the cylinder nut 8 and configured for rotating the cylinder nut 8 around the rotational axis X. The actuator M is rotatably displacing the cylinder nut 8 in a first rotational direction D_{R1} and a second rotational direction D_{R2} respectively. The rotational displacement of the cylinder nut 8 is through the engagement between the piston rod 7 and the cylinder nut 8 resulting in linear displacement of the piston rod 7 and the piston 6 relative to the cylinder barrel 5 for moving the upper section 1a with the labelling unit 2 in the vertical direction Z. The actuator M is in this way upon actuation displacing the upper section 1a with the labelling unit 2 in the vertical direction Z. As shown in FIG. 6b, the actuator M is arranged inside the space formed by the upper section 1a and the lower section 1b. The actuator M can be designed as a variable speed drive unit for controlling the speed of the labelling unit 2 displacement in the vertical direction Z.

The actuator M may be of any suitable type, such as for example an electric motor. The type of electric motor can be chosen to fit the specific design of the lifting device 1. In order to control the displacement of the labelling unit 2 in the vertical direction Z with high precision, the actuator M is suitably arranged as a stepper motor adapted for rotatably positioning the cylinder nut 8 with high precision. The stepper motor can be controlled by a control unit to secure the displacement of the upper section 1a in relation to the lower section 1b with high precision, where the stepper motor with high accuracy in a stepwise manner is rotating the cylinder nut 8 into a desired rotational position. Since the stepper motor can be controlled with incremental steps, the positioning of the labelling unit 2 can be made with high precision compared to traditional high power electric motors normally used in lifting devices.

The actuator M is used for controlling the position of the labelling unit 2 in the vertical direction Z in relation to the flow of objects 3 through displacing the upper section 1a in the upwards direction D_{U} and in the downwards direction D_{D} to a labelling position P_{LAB} Of the labelling unit 2. In the labelling position P_{LAB}, the labels 4 are printed and/or applied to the objects 3.

By rotating the cylinder nut 8 in a first rotational direction D_{R1} around a rotational axis X, as shown in FIG. 6b, the piston rod 7 with the piston 6 is linearly displaced in a first direction D₁ relative to the cylinder barrel 5 through the engagement between the cylinder nut 8 and the piston rod 7, and the piston rod 7 is in this way displaced out from the cylinder barrel 5. It should be understood that the piston 6 is linearly displaced with the piston rod 7 in the first direction D₁ due to the connection of the piston rod 7 to the piston 6. The first direction D₁ is in the shown embodiment corresponding to the upwards direction D_{U}. Due to the further connection between the piston rod 7 and the upper section 1a, the upper section 1a with the labelling unit 2 is displaced in the upwards direction D_{U}, when the piston rod 7 is rotated in the first rotational direction D_{R1} around the rotational axis X.

By rotating the cylinder nut 8 in a second rotational direction D_{R2} around the rotational axis X, the piston rod 7 with the pion 6 is linearly displaced in a second direction D₂ relative to the cylinder barrel 5 through the engagement between the cylinder nut 8 and the piston rod 7, and the piston rod 7 is in this way displaced into the cylinder barrel 5. The second rotational direction D_{R2} is opposite the first rotational direction D_{R1}. It should be understood that the piston 6 is linearly displaced with the piston rod 7 in the second direction D₂ due to the connection of the piston rod 7 to the piston 6. The second direction D₂ is in the shown embodiment corresponding to the downwards direction D_{D}. Due to the further connection between the piston rod 7 and the upper section 1a, the upper section 1a with the labelling unit 2 is displaced in the downwards direction D_{D}, when the piston rod 7 is rotated in the second rotational direction D_{R2} around the rotational axis X.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1: Lifting device
1a: Upper section
1a_{L}: Lower part, upper section
1a_{SW}: Side wall, upper section
1b: Lower section
1b_{SW}: Side wall, lower section
1b_{U}: Upper part, lower section
2: Labelling unit
3: Object
4: Label
5: Cylinder barrel
6: Piston
7: Piston rod
7a: Inner end
7b: Outer end
8: Cylinder nut
9: Load balancing pressure chamber
10a: Upper support bracket
10b Lower support bracket
11: Air pressure source
12: Safety brake arrangement
13: Piston bearing unit
14: Nut bearing unit
15: Flow port
16: Support surface
17: Support arm
18: Bracket bearing
19: Belt drive arrangement
A: Air
D_{R1}: First rotational direction
D_{R2}: Second rotational direction
D₁: First direction
D₂: Second direction
D_{D}: Downwards direction
D_{U}: Upwards direction
F_{G}: Gravitational force
F_{C}: Counterbalancing force
M: Actuator
P: Fluid pressure
PL: Lowered position
P_{LAB}: Labelling position
P_{R}: Raised position
S: Safety labelling system
T: Transporting unit
U: Balancing displacement unit
X: Rotational axis
Z: Vertical direction

1. A safety labelling system comprising a lifting device and a labelling unit, wherein the lifting device is configured for positioning the labelling unit in a vertical direction in relation to a flow of objects, wherein the labelling unit is arranged for printing labels and/or applying labels to the objects,
wherein the lifting device comprises an upper section and a lower section, wherein the upper section is movably arranged relative to the lower section by means of a balancing displacement unit arranged between the upper section and the lower section, wherein the labelling unit is attached to the upper section,
wherein the balancing displacement unit comprises a cylinder barrel, a piston movably arranged in the cylinder barrel, a piston rod, and a cylinder nut, wherein the piston rod and the cylinder nut are rotatably engaged with each other, wherein the piston rod at an inner end is connected to the piston and the cylinder nut is connected to the cylinder barrel, wherein an actuator is configured for rotatably displacing the piston rod or the cylinder nut resulting in linear displacement of the piston rod and the piston relative to the cylinder barrel for moving the upper section with the labelling unit in the vertical direction,
wherein the balancing displacement unit further comprises a load balancing pressure chamber arranged in the cylinder barrel in connection to the piston, wherein the load balancing pressure chamber is configured for counterbalancing a gravitational force exerted on the piston rod from the safety labelling system by applying a counterbalancing force onto the piston by means of fluid pressure in the load balancing pressure chamber.

2. The safety labelling system according to claim 1,
wherein the inner end of the piston rod is rotatably connected to the piston via a piston bearing unit, wherein the cylinder nut is non-rotatably connected to the cylinder barrel, wherein the actuator is connected to the piston rod and configured for rotating the piston rod around a rotational axis upon actuation for displacement of the upper section with the labelling unit in the vertical direction.

3. The safety labelling system according to claim 1,
wherein the inner end of the piston rod is non-rotatably connected to the piston, wherein the cylinder nut is rotatably connected to the cylinder barrel via a nut bearing unit, wherein the actuator is connected to the cylinder nut and configured for rotating the cylinder nut around a rotational axis upon actuation for displacement of the upper section with the labelling unit in the vertical direction.

4. The safety labelling system according to claim 1,
wherein the balancing displacement unit is arranged inside the upper section and the lower section.

5. The safety labelling system according to claim 1,
wherein the upper section and the lower section are telescopically arranged relative to each other.

6. The safety labelling system according to claim 1,
wherein an outer end of the piston rod is connected to the upper section, and wherein the cylinder barrel is connected to the lower section.

7. The safety labelling system according to claim 6,
wherein the upper section comprises an upper support bracket and the lower section comprises a lower support bracket, wherein the outer end of the piston rod is connected to the upper support bracket and the cylinder barrel is connected to the lower support bracket.

8. The safety labelling system according to claim 1,
wherein the piston rod is configured as a ball screw and the cylinder nut is configured as a ball nut, or wherein the piston rod is configured as a threaded screw and the cylinder nut is configured as a threaded nut.

9. The safety labelling system according to claim 1,
wherein the actuator is arranged to control the position of the labelling unit in the vertical direction in relation to the flow of objects through displacing the upper section in an upwards direction and/or a downwards direction to a labelling position of the labelling unit, wherein in the labelling position the labels are printed and/or applied to the objects.

10. The safety labelling system according to claim 1,
wherein the load balancing pressure chamber is configured as a pneumatic cylinder chamber, wherein the load balancing pressure chamber is pressurized by means of compressed air from an air pressure source for establishing the counterbalancing force onto the piston for counterbalancing the gravitational force exerted on the piston rod.

11. The safety labelling system according to claim 1,
wherein the actuator is arranged inside the upper section and/or the lower section.

12. The safety labelling system according to claim 1,
wherein the actuator is a stepper motor adapted for rotatably positioning the piston rod or the cylinder nut with high precision.

13. The safety labelling system according to claim 1,
wherein the safety labelling system is provided with a safety brake arrangement configured to prevent the upper section from unwanted displacement from the gravitational force exerted on the piston rod if a malfunction of the balancing displacement unit occurs.

14. A method for operating a safety labelling system, wherein the safety labelling system comprises a lifting device and a labelling unit, wherein the lifting device is positioning the labelling unit in a vertical direction in relation to a flow of objects, wherein the labelling unit is printing labels and/or applying labels to the objects,
wherein the lifting device comprises an upper section and a lower section, wherein the upper section is movably arranged relative to the lower section by means of a balancing displacement unit arranged between the upper section and the lower section, wherein the labelling unit is attached to the upper section,
wherein the balancing displacement unit comprises a cylinder barrel, a piston movably arranged in the cylinder barrel, a piston rod, and a cylinder nut, wherein the piston rod and the cylinder nut are rotatably engaged with each other, wherein the piston rod at an inner end is connected to the piston and the cylinder nut is connected to the cylinder barrel, wherein the balancing displacement unit further comprises a load balancing pressure chamber arranged in the cylinder barrel in connection to the piston, wherein the method comprises the steps:
rotatably displacing the piston rod or the cylinder nut by means of an actuator, wherein the rotational displacement of the piston rod or the cylinder nut is resulting in linear displacement of the piston rod and the piston relative to the cylinder barrel for moving the upper section with the labelling unit in the vertical direction;
counterbalancing a gravitational force exerted on the piston rod from the safety labelling system by applying a counterbalancing force onto the piston means of fluid pressure in the load balancing pressure chamber.

15. The method according to claim 14,
wherein the inner end of the piston rod is rotatably connected to the piston via a piston bearing unit, wherein the cylinder nut is non-rotatably connected to the cylinder barrel, wherein the actuator is connected to the piston rod, wherein the method further comprises the step:
rotating the piston rod around a rotational axis by the actuator for displacing the upper section with the labelling unit in the vertical direction,

16. The method according to claim 14,
wherein the inner end of the piston rod is non-rotatably connected to the piston, wherein the cylinder nut is rotatably connected to the cylinder barrel via a nut bearing unit, wherein the actuator is connected to the cylinder nut, wherein the method further comprises the step:
rotating the cylinder nut around a rotational axis by the actuator for displacing the upper section with the labelling unit in the vertical direction.

17. The method according to claim 14,
wherein the method further comprises the step: controlling the position of the labelling unit in the vertical direction in relation to the flow of objects by means of the actuator, by displacing the upper section in an upwards direction and/or a downwards direction to a labelling position of the labelling unit, wherein in the labelling position the labels are printed and/or applied to the objects.

18. The method according to claim 14,
wherein the load balancing pressure chamber is configured as a pneumatic cylinder chamber, wherein the method further comprises the step: pressurizing the load balancing pressure chamber by means of compressed air from an air pressure source for establishing the counterbalancing force onto the piston for counterbalancing the gravitational force exerted on the piston rod.

19. The method according to claim 14,
wherein the safety labelling system is provided with a safety brake arrangement, wherein the method further comprises the step: preventing the upper section from unwanted displacement from the gravitational force exerted on the piston rod if a malfunction of the balancing displacement unit occurs by means of the safety brake arrangement.
